(19) United States
(12) Patent Application Publication
(10) Pub. No.: US 2016/0175890 A1
(43) Pub. Date: Jun. 23, 2016

(54) TARGETED CLEANER FOR CLEANING METAL SURFACES

(71) Applicant: Crown Chief Technology Innovation Co., Ltd., New Taipei City (TW)

(72) Inventor: Yin-Yen Hsu, Taipei City (TW)

(21) Appl. No.: 14/936,070

(22) Filed: Nov. 9, 2015

(30) Foreign Application Priority Data
Dec. 19, 2014 (TW) 103222472

(51) Int. Cl. B08B 1/00; B32B 9/00; B32B 15/04; B32B 27/36; B32B 7/12; B32B 5/18

(52) U.S. Cl. CPC B08B 1/001; B32B 7/12; B32B 5/18; B32B 15/04; B32B 27/36; B32B 9/005; B32B 2432/00; B32B 2266/0278

(57) ABSTRACT

Provided is a targeted cleaner for cleaning metal surfaces which comprises a surface, an adhesive and a support. The adhesive is positioned between the surface and the support. The targeted cleaner for cleaning metal surfaces is applied to a detection equipment to remove the dirt formed on the inspection station of the detection equipment during detected subject examination and further remove the irregular electrical resistance, capacitance, and inductance to decrease the erroneous detection of the defective products and enhance yield of the examination. Furthermore, users do not have to spend time dissembling the detection equipment for cleaning the dirt, and time consumption during closing down of the detection equipment can be saved.

### BACKGROUND OF THE INVENTION

1. Field of the Invention

The present invention relates to a targeted cleaner, especially to a targeted cleaner for cleaning metal surfaces to remove the dirt formed on an inspection station of the detection equipment during examination.

2. Description of the Prior Art

FIGS. 4A and 4B refer to a detected subject applied on a carrier 40′ and examined by a metal detector on an inspection station 60 of the detection equipment. Upon examining a certain amount of the detected subject, dirt 70 will be formed on the inspection station 60 of the detection equipment, causing irregular electrical resistance, capacitance, and inductance to be produced on a surface of the detected subject connected to the metal detector. The irregular electrical resistance, capacitance, and inductance would influence the quality of examination and causes erroneous detection followed by producing defective products. Therefore, repeated examination is needed to avoid such erroneous detection.

To remove the dirt 70, the detection equipment or detecting apparatus should be closed down, and users have to spend much time dissembling the complex detection equipment or detecting apparatus for cleaning the dirt.

However, it is not efficient because operation of detected subject examination would be interrupted and cost of detected subject examination would be increased once the detection equipment or detecting apparatus is closed down.

### SUMMARY OF THE INVENTION

To overcome the shortcomings, the present invention provides a targeted cleaner for cleaning metal surfaces to mitigate or obviate the aforementioned problems.

The targeted cleaner for cleaning metal surfaces in accordance with the present invention comprises a surface, an adhesive and a support, wherein the adhesive is positioned between the surface and the support.

Preferably, the targeted cleaner further comprises a flexible handle disposed in a center of the targeted cleaner.

Preferably, the surface is made of mixture of resin, abrasive and polyurethane foam to form on a polyethylene terephthalate (PET) film.

Preferably, the size of the targeted cleaner is cut dependent on the size of a carrier which is connected to the targeted cleaner.

As applying the targeted cleaner for cleaning metal surfaces of the present invention to a detection equipment or detecting apparatus, the targeted cleaner for cleaning metal surfaces can remove the dirt formed on an inspection station of the detection equipment during examination and further remove the irregular electrical resistance, capacitance, and inductance to decrease the erroneous detection of the defective products and enhance yield of the examination. Furthermore, owing to that the targeted cleaner for cleaning metal surfaces can remove the dirt formed on the inspection station of the detection equipment immediately during the examination, users do not have to spend time dissembling the detection equipment or detecting apparatus for cleaning the dirt, and the period of time during closing down of the detection equipment or detecting apparatus can be saved.

### BRIEF DESCRIPTION OF THE DRAWINGS

FIG. 1A is a side-sectional view of a targeted cleaner for cleaning metal surfaces in accordance with the present invention;

FIG. 1B is a side-sectional view of another embodiment of the targeted cleaner for cleaning metal surfaces in accordance with the present invention;

FIG. 2A is an exploded perspective view of the targeted cleaner for cleaning metal surfaces in FIG. 1;

FIG. 2B is an exploded perspective view of said another embodiment in accordance with the present invention;

FIG. 3A is a side-sectional view of the targeted cleaner for cleaning metal surfaces in a usage state in FIG. 1;

FIG. 3B is a side-sectional view of said another embodiment in a usage state in accordance with the present invention;

FIG. 4A is a side-sectional view of a conventional targeted cleaner; and

FIG. 4B is a side-sectional view of said conventional targeted cleaner in use.

### DETAILED DESCRIPTION OF THE PREFERRED EMBODIMENTS

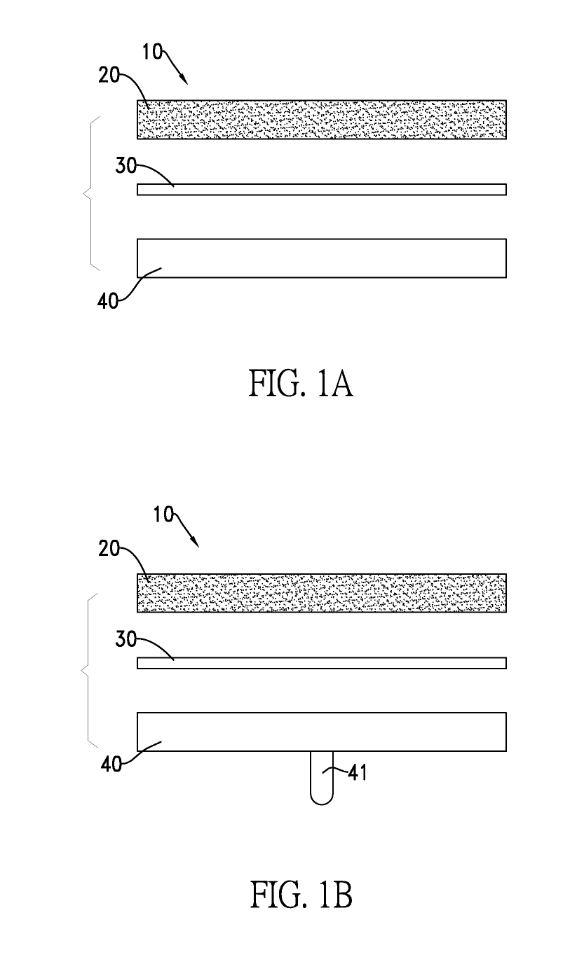

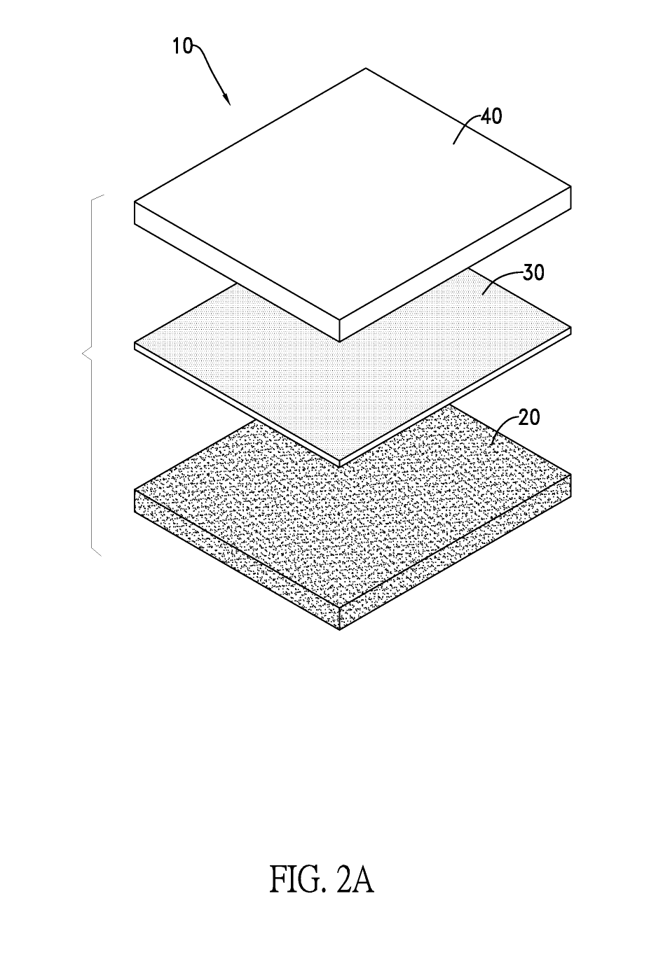

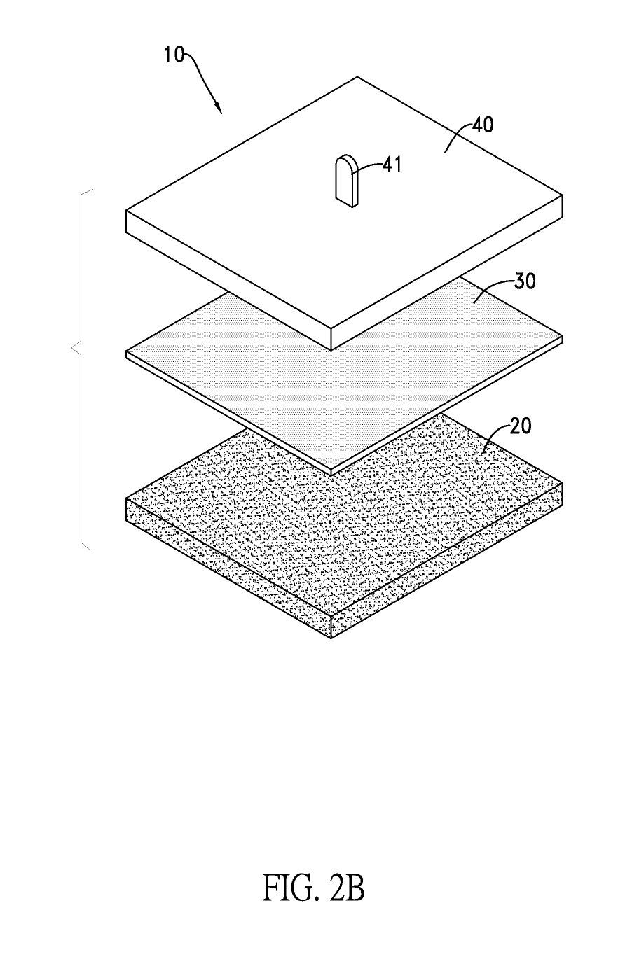

With references to Figs. 1A and 2A, a targeted cleaner 10 for cleaning metal surfaces in accordance with the present invention comprises a surface 20, an adhesive 30, and a support 40. The adhesive 30 is positioned between the surface 20 and the support 40, and the adhesive 30 connects the surface 20 with the support 40.

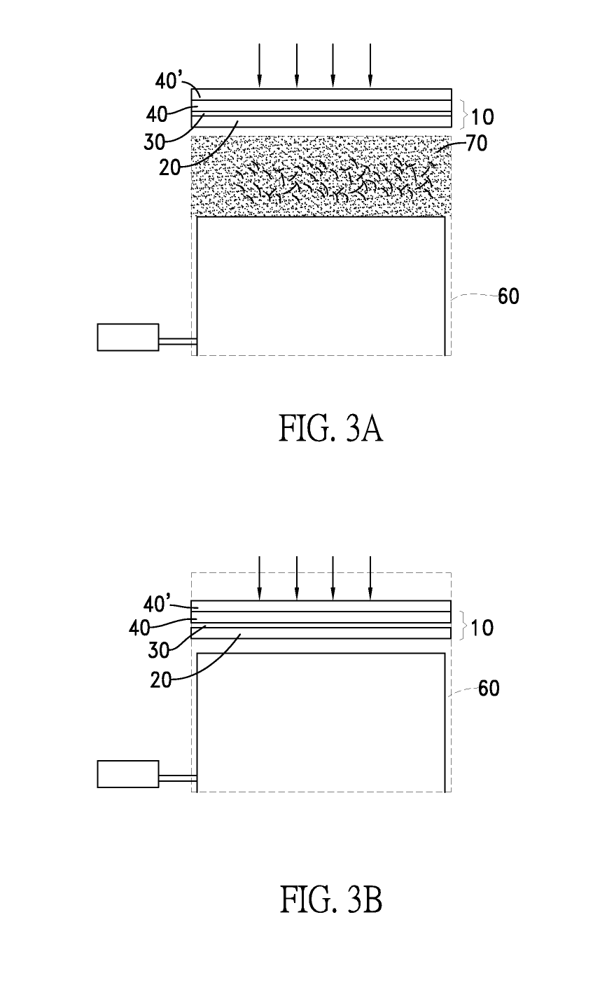

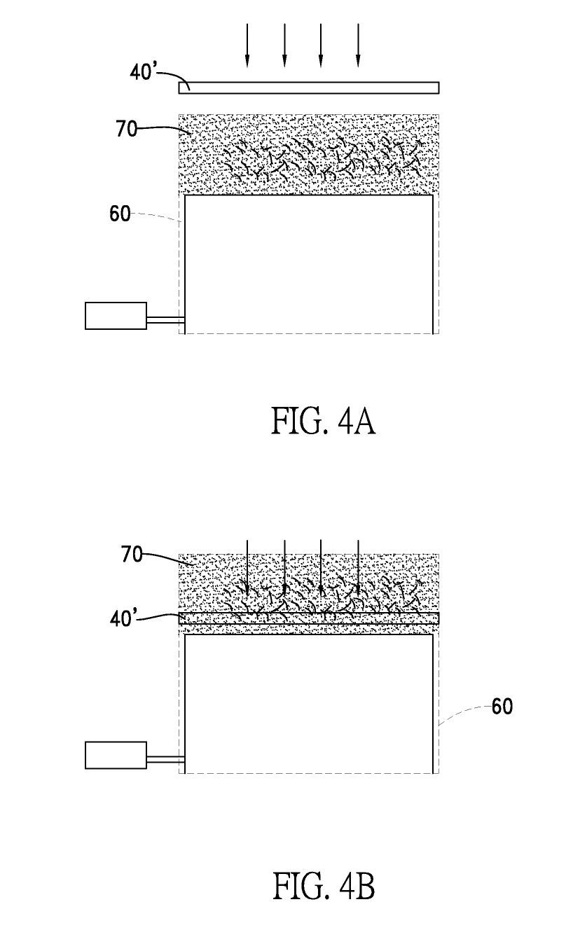

The surface 20 is made of mixture of resin, abrasive and polyurethane foam to form on a PET film. The support 40 is made of metal, plastic, or pottery. With references to FIG. 3A, in a preferred embodiment, the size of the targeted cleaner 10 is cut dependent on the size of a carrier 40′ which is connected to the targeted cleaner 10.

In a preferred embodiment, with references to FIGS. 1B and 2B, the targeted cleaner 10 for cleaning metal surfaces in accordance with the present invention further comprises a flexible handle 41 disposed in a center of the support 40 of the targeted cleaner 10. With references to FIGS. 2A, 3A and 3B, the targeted cleaner 10 is applied to a detection equipment or detecting apparatus. In particular, a detected subject is applied on the carrier 40′ and examined by a metal detector on an inspection station 60 of the detection equipment. Upon examining a certain amount of the detected subject, dirt 70 would be formed on the inspection station 60 of the detection equipment, causing irregular electrical resistance, capacitance, and inductance to be produced on a surface of the detected subject connected to the metal detector. The irregular electrical resistance, capacitance, and inductance would influence the quality of examination and causes erroneous detection followed by producing defective products. Therefore, repeated examination is needed to avoid such erroneous detection. According to the targeted cleaner 10 for cleaning metal surfaces of the present invention, the targeted cleaner 10 is connected to a bottom of the carrier 40′ applied with the detected subject by the adhesive 30. Once the targeted cleaner 10 passes the inspection station 60 of the detection equipment and is examined by the metal detector, the targeted cleaner 10 can remove the dirt 70 and further remove the irregular electrical resistance, capacitance, and inductance to decrease the erroneous detection of the defective products and enhance yield of the examination.

What is claimed is:

1. A targeted cleaner for cleaning metal surfaces, wherein the targeted cleaner comprises a surface, an adhesive and a support, and the adhesive is positioned between the surface and the support.

2. The targeted cleaner for cleaning metal surfaces as claimed in claim 1, wherein the targeted cleaner further comprises a flexible handle, wherein the handle is disposed in a center of the support of the targeted cleaner.

3. The targeted cleaner for cleaning metal surfaces as claimed in claim 1, wherein the surface is made of mixture of resin, abrasive and polyurethane foam to form on a polyethylene terephthalate (PET) film.

4. The targeted cleaner for cleaning metal surfaces as claimed in claim 1, wherein the size of the targeted cleaner is cut dependent on the size of a carrier which is connected to the targeted cleaner.

5. The targeted cleaner for cleaning metal surfaces as claimed in claim 1, wherein the support is made of metal.

6. The targeted cleaner for cleaning metal surfaces as claimed in claim 1, wherein the support is made of plastic.

7. The targeted cleaner for cleaning metal surfaces as claimed in claim 1, wherein the support is made of pottery.
